(19) United States
(12) Patent Application Publication
(10) Pub. No.: US 2019/0315551 A1
(43) Pub. Date: Oct. 17, 2019

(54) MEALS PACKAGED FOR COOKING IN COOKING APPARATUS WITH INDIVIDUALLY CONTROLLABLE COOKING ZONES

(71) Applicant: Walmart Apollo, LLC, Bentonville, AR (US)

(72) Inventors: Greg A. Bryan, Bentonville, AR (US); Kurt William Robert Bessel, Mexico, NY (US); Brian Charlesworth, Bentonville, AR (US); David G. Tovey, Rogers, AR (US); Eric Letson, Bentonville, AR (US)

(21) Appl. No.: 16/381,895

(22) Filed: Apr. 11, 2019

Related U.S. Application Data
(60) Provisional application No. 62/657,347, filed on Apr. 13, 2018.

(51) Int. Cl. B65D 81/34

(52) U.S. Cl. CPC B65D 81/34; B32B 2439/70; B65D 2581/34

(57) ABSTRACT

A meal kit and a method of using the meal kit are presented. The meal kit includes a liner for a network-connected cooking apparatus, the liner having multiple segmented areas, each segmented area containing a food product. The liner also includes a machine-readable code disposed on the liner that is utilized to access information relating to cooking temperature and cooking time for each segment. The liner is configured to be placed into a cooking apparatus and align with different individually controllable cooking zones in the cooking apparatus.

### CROSS-REFERENCE TO RELATED PATENT APPLICATIONS

This application claims priority to U.S. Provisional Application No. 62/657,347, filed on Apr. 13, 2018, the content of which is hereby incorporated by reference in its entirety.

### BACKGROUND

There are many different types of meal kits. One type of meal kit is a frozen prepared meal, referred to as a frozen dinner or TV dinner, which typically involves separate food servings filled into and frozen in serving trays of a container that are thawed and heated using a microwave or conventional convection oven. Many frozen meal components may be significantly inferior in taste and appearance after cooking for consumption. Frozen meals that are baked often require a relatively long baking period as the food must be thawed or defrosted. In addition, baked frozen meals also tend to have deterioration in the texture and taste of the food components of the meal.

Other types of meal kits that are available are sold without the meat ingredient. This type of meal kit requires the consumer to separately obtain, store, add, and cook a meat ingredient together with other ingredients that are packaged and sold together with the meal kit. Such non-complete meal kits requiring consumers to separately procure and store the meat dish portion needed for the meal kit offer limited convenience to the consumer.

### SUMMARY

Exemplary embodiments of the present invention provide a meal kit that is packaged for cooking in a network-connected cooking apparatus. The meal kit has divided ingredients in a liner and a machine-readable identifier linked to cooking instructions. The meal kit is configured to be placed into the cooking apparatus and to align with different temperature zones in the cooking apparatus. The cooking apparatus can cook the different food items contained within the meal kit at different temperatures and times to achieve a meal on schedule.

In one embodiment, a meal kit comprises a liner for a cooking apparatus having a plurality of individually controllable cooking zones, the liner having a plurality of segmented areas, each segmented area containing a food product. The meal kit also has a machine-readable code disposed on the liner, the machine-readable code providing access to information relating to cooking temperature and cooking time for each segment, the information indicating at least two of the segments to be cooked for at least one of a different length of time and a different temperature from each other. The liner is configured to be placed into a cooking apparatus and the segments are aligned with different cooking zones in the cooking apparatus.

In another embodiment, a computer-implemented method for using a meal kit includes providing a liner for a cooking apparatus having a plurality of individually controllable cooking zones, the liner having a plurality of segmented areas, each segmented area containing a food product. The method further includes reading a machine-readable code disposed on the liner, the machine-readable code providing access to information relating to cooking temperature and cooking time for each segment, the information indicating at least two of the segments to be cooked for at least one of a different length of time and a different temperature from each other. The liner is configured to be placed into the cooking apparatus and align with the individually controllable cooking zones such that the plurality of segmented areas align with the plurality of cooking zones in the cooking apparatus.

### BRIEF DESCRIPTION OF THE DRAWINGS

The accompanying drawings, which are incorporated in and constitute a part of this specification, illustrate one or more embodiments of the invention and, together with the description, help to explain the invention. The drawings are not necessarily to scale, or inclusive of all elements of a system, emphasis instead generally being placed upon illustrating the concepts, structures, and techniques sought to be protected herein. In the drawings:

FIG. 1 is a block diagram showing a meal kit according to an example embodiment.

FIG. 2 is a block diagram showing a meal kit having horizontally aligned segments, according to an example embodiment.

FIG. 3 is a block diagram showing a meal kit having vertically aligned segments, according to an example embodiment.

FIG. 4 is a block diagram showing a meal kit having separated segments, according to an example embodiment.

FIG. 5 is a flowchart illustrating an exemplary method for using a meal kit, according to an example embodiment.

### DETAILED DESCRIPTION

Embodiments of the present invention provide a simplified way to prepare a meal. A user can select a meal kit before heading out to work, have the label on the meal kit read by a scanner included in the cooking apparatus so that cooking directions are obtained, place the meal kit into a cooking apparatus and specify a finish time. The retrieved cooking directions are used to control separate cooking zones in the cooking apparatus. When the user gets home from work, there is a fully cooked meal waiting for him or her. There is no preparation required, no user intervention during the cooking process, and clean up may be simplified.

In one embodiment, the meal kits include a recyclable or disposable liner that may have segmented areas for different ingredients that align with separate cooking zones. In an embodiment, the meal kit is non-symmetrically shaped so the meal kit will only fit in the cooking apparatus in one orientation in which the different meal kit segments are aligned with different cooking zones. The liner includes a machine-readable code on the outside of the liner which is read by the cooking apparatus to obtain directions to control the temperature/time for each cooking zone in the cooking apparatus. In an embodiment, the retrieved instructions may be adjustable by a user via the cooking apparatus to allow the user to customize the meal by cooking until the food is extra tender, al dente, etc.

In one embodiment, spice packages can be provided with the meal kit to allow the user to choose their desired level of spice. The packets may be adjacent to or included in a segmented area of the meal kit liner. The cooking apparatus may include mechanical means for puncturing a selected number of spice packages to provide the desired spice level. For example, the meal kit contains five spice packages and the user desires three alarm chili. The cooking apparatus will puncture three spice packages.

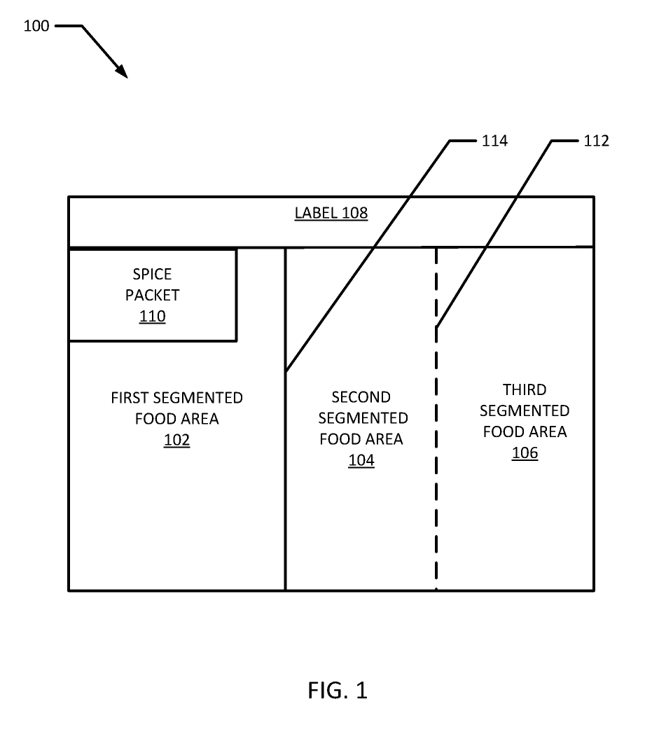

FIG. 1 is a block diagram showing a meal kit 100 in an exemplary embodiment. The meal kit 100 has three distinct segments 102, 104 and 106, each containing a food product. For example, the food product may be a protein, a starch, a vegetable, a sauce or gravy, a dessert, a fruit etc. The meal kit 100 also includes a label 108. The label is read by a scanning element in the cooking apparatus and is used to obtain cooking directions for the meal kit from a network-accessible location. The cooking directions typically include a temperature and cooking time for each segment. Meal kit 100 also includes a permeable barrier 112 between second segmented food area 104 and third segmented food area 106. The permeable barrier 112 allows the different segmented food areas 104 and 106 to share flavors. Barrier 114 is solid and does not allow for any flavors to be shared between food segments 102 and 104. As noted above, spice packet 110 may be punctured to add spice to segment 102.

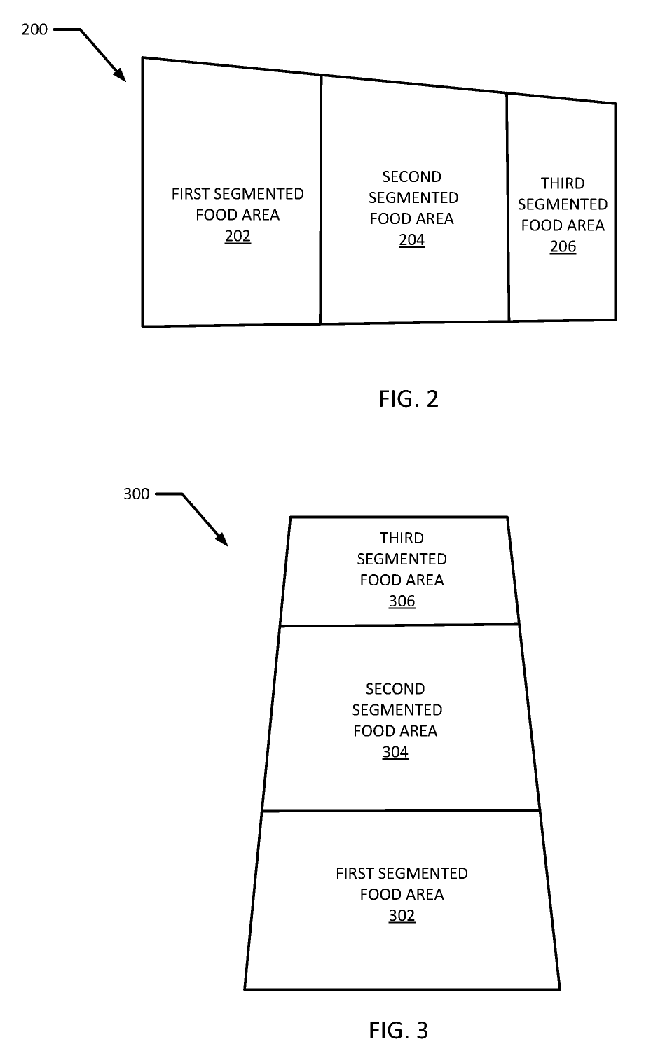

FIG. 2 is a block diagram showing a meal kit 200 in an exemplary embodiment. The meal kit 200 has three distinct segments 202, 204 and 206, each containing a food product. The segmented areas 202, 204 and 206 are aligned horizontally in this embodiment. One segment can include a protein, another segment can include a starch, and another segment can include a vegetable, resulting in a complete meal. This style meal kit is for use in a cooking apparatus that has three cooking zones which are also aligned horizontally and align with the meal kit when the meal kit is inserted into the cooking apparatus, which each segment aligned with a respective cooking zone of the cooking apparatus.

FIG. 3 is a block diagram showing a meal kit 300 in an exemplary embodiment. The meal kit 300 has three distinct segments 302, 304 and 306, each containing a food product. The segmented areas 302, 304 and 306 are aligned vertically in this embodiment. One segment can include a protein, another segment can include a starch, and another segment can include a vegetable, resulting in a complete meal. This style meal kit is for use in a cooking apparatus that has three cooking zones which are also aligned vertically and align with the meal kit when the meal kit is inserted into the cooking apparatus, which each segment aligned with a respective cooking zone of the cooking apparatus.

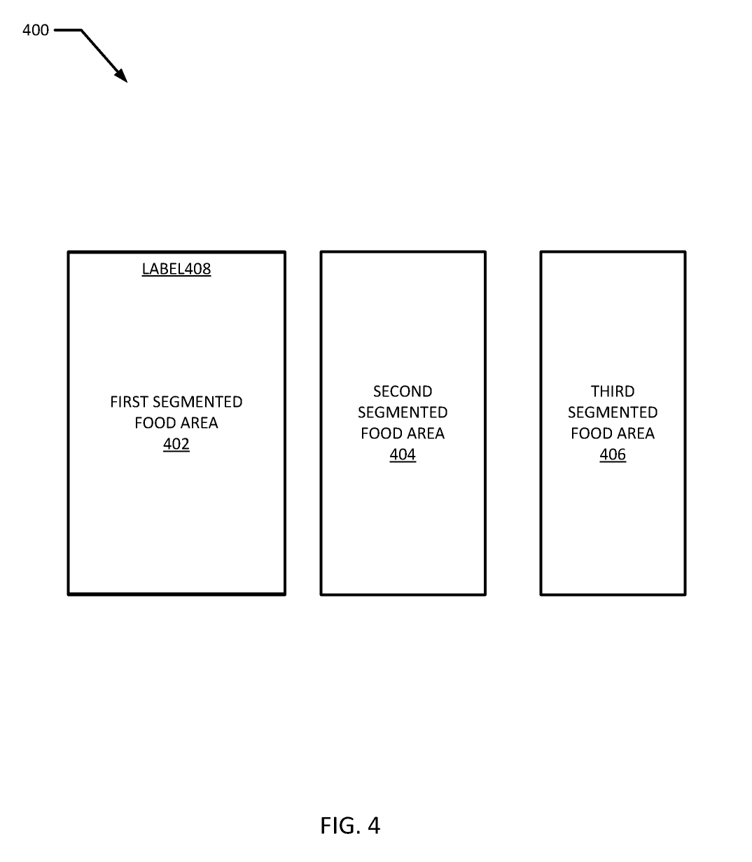

FIG. 4 is a block diagram showing a meal kit 400 in an exemplary embodiment. The meal kit 400 has three distinct and separate segments 402, 404 and 406, each containing a food product. One segment can include a protein, another segment can include a starch, and another segment can include a vegetable, resulting in a complete meal. Each segment may be stored separately and later inserted into a liner. For example, first segmented food area 402 may be stored in a freezer and kept frozen until ready for cooking, while second segmented area 404 may be stored in a refrigerator and kept refrigerated until ready for cooking, and third segmented food area 406 may be stored at room temperature until cooking. This style meal kit is for use in a cooking apparatus that has three cooking zones. Each segment is aligned with a cooking zone when the meal kit segments are inserted into the cooking apparatus. It will be appreciated that some embodiments may have meal kit liners with more or less than three segments designed to be inserted into a cooking apparatus having a similar number of cooking zones. In another embodiment, the meal kit liner may have fewer segments than the cooking apparatus has cooking zones.

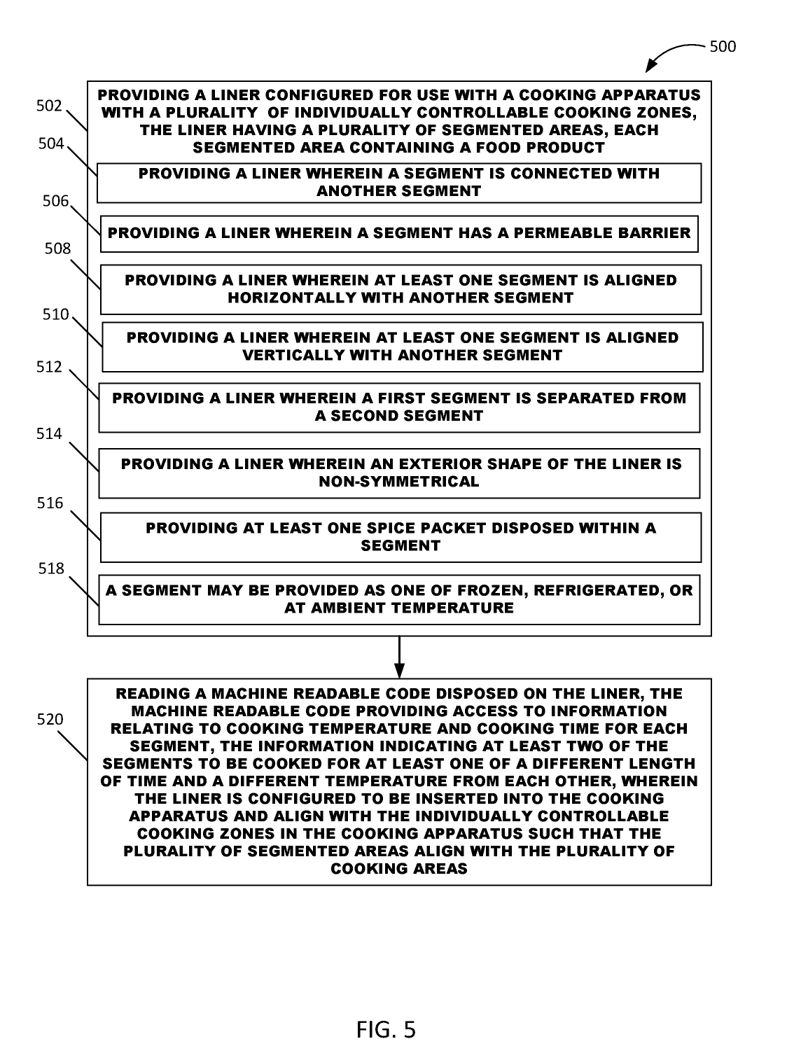

FIG. 5 is a flowchart illustrating an exemplary method 500 for using a meal kit, according to an example embodiment. The sequence begins by providing a liner for a cooking apparatus having multiple cooking zones. The liner has multiple segmented areas that each contain a food product (step 502). Each segment can contain a different part of a meal. For example one segment can contain a protein, another segment a starch, and another segment as vegetable.

The liner may include a segment that is connected with another segment (step 504). In one embodiment all the segments are connected, thus a single meal kit includes all the segments as one liner, and the meal kit including all the connected segments can be placed into the crockpot.

The liner may include a segment that has a permeable barrier (step 506). The permeable barrier allows the different segmented food areas to share flavors.

The liner may include at least one segment that is aligned horizontally with another segment (step 508). This embodiment is useful when using a cooking apparatus which also has horizontally aligned cooking zones.

The liner may include at least one segment that is aligned vertically with another segment (step 510). This embodiment is useful when using a cooking apparatus which also has vertically aligned cooking zones.

The liner may include a first segment that is separated from a second segment (step 512). Each segment may be stored separately. For example, a first segmented food area may be stored in a freezer and kept frozen until ready for cooking, while a second segmented area may be stored in a refrigerator and kept refrigerated until ready for cooking, and a third segmented food area may be stored at room temperature until ready for cooking.

The liner may have an exterior shape that is non-symmetrical (step 514). This allows the meal kit to be positioned in a cooking apparatus at a predetermined orientation such that the segments are aligned with the cooking zones.

The liner may have at least one spice packet disposed within a segment (step 516). Spice packages can be provided with the meal kit to allow the user to choose their desired level of spice. The cooking apparatus can puncture the corresponding number of spice packages to provide the desired spice level.

The segments may be provided as one of frozen, refrigerated, or at ambient temperature (step 518).

As the meal kit liner is inserted into the cooking apparatus, a scanning element in the cooking apparatus reads a machine-readable code disposed on the liner (step 520) The machine-readable code provides access to information relating to cooking temperature and cooking time for each segment that indicates at least two of the segments are to be cooked for at least one of a different length of time and a different temperature from each other. The liner is configured to be placed into a cooking apparatus so that the segments in the liner align with different temperature zones in the cooking apparatus.

The description is presented to enable a person skilled in the art to create and use a meal kit and related method and systems for cooking the meal. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts have been provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be provided separately or in any suitable sub-combination. Accordingly, it is submitted that the scope of protection sought herein should not be limited to the described embodiments but rather should be limited only by the spirit and scope of the following claims.

What is claimed is:

1. A meal kit comprising:
a liner configured for use with a cooking apparatus with a plurality of individually controllable cooking zones the liner having a plurality of segmented areas, each segmented area containing a food product; and
a machine-readable code disposed on the liner, the machine-readable code providing access to information relating to cooking temperature and cooking time for each segment, the information indicating at least two of the segments to be cooked for at least one of a different length of time and a different temperature from each other, wherein the liner is configured to be inserted into the cooking apparatus and align with the individually controllable cooking zones in the apparatus such that the plurality of segmented areas align with the plurality of cooking areas.

2. The meal kit of claim 1, wherein a segment is connected with another segment.

3. The meal kit of claim 1, wherein at least one segment includes a permeable barrier.

4. The meal kit of claim 1, wherein at least two segments are aligned horizontally.

5. The meal kit of claim 1, wherein at least two segments are aligned vertically.

6. The meal kit of claim 1, wherein a first segment is separated from a second segment.

7. The meal kit of claim 1, wherein an exterior shape of the meal kit is non-symmetrical.

8. The meal kit of claim 1, further comprising at least one spice packet disposed within a segment.

9. The meal kit of claim 1, wherein a segment may be one of frozen, refrigerated, or at ambient temperature.

10. The meal kit of claim 1, further comprising a network accessible storage repository of meal kit information from which the information relating to cooking temperature and cooking time for each segment is retrieved by the cooking apparatus after scanning the machine-readable code disposed on the liner.

11. A method for using a meal kit, the method comprising:
providing a liner configured for use with a cooking apparatus with a plurality of individually controllable cooking zones, the liner having a plurality of segmented areas, each segmented area containing a food product;
reading a machine-readable code disposed on the liner, the machine-readable code providing access to information relating to cooking temperature and cooking time for each segment, the information indicating at least two of the segments to be cooked for at least one of a different length of time and a different temperature from each other, wherein the liner is configured to be inserted into the cooking apparatus and align with the individually controllable cooking zones in the cooking apparatus such that the plurality of segmented areas align with the plurality of cooking areas.

12. The method of claim 11, wherein providing a liner having a plurality of segmented areas further comprises providing a liner wherein a segment is connected with another segment.

13. The method of claim 11, wherein providing a liner having a plurality of segmented areas further comprises providing a liner wherein a segment has a permeable barrier.

14. The method of claim 11, wherein providing a liner having a plurality of segmented areas further comprises providing a liner wherein at least one segment is aligned horizontally with another segment.

15. The method of claim 11, wherein providing a liner having a plurality of segmented areas further comprises providing a liner wherein at least one segment is aligned vertically with another segment.

16. The method of claim 11, wherein providing a liner having a plurality of segmented areas further comprises providing a liner wherein a first segment is separated from a second segment.

17. The method of claim 11, wherein providing a liner having a plurality of segmented areas further comprises providing a liner wherein an exterior shape of the liner is non-symmetrical.

18. The method of claim 10, wherein providing a liner having a plurality of segmented areas further comprises providing at least one spice packet disposed within a segment.

19. The method of claim 10, wherein a segment may be provided as one of frozen, refrigerated, or at ambient temperature.

20. A system comprising:
a cooking apparatus having a plurality of individually controllable cooking zone;
a meal kit configured for use with the cooking apparatus, the meal kit including a liner having a plurality of segments, the meal kit disposable within the cooking apparatus, the meal kit having a machine-readable code disposed on the liner providing access to information relating to cooking temperature and cooking time for each segment, the information indicating at least two of the segments to be cooked for at least one of a different length of time and a different temperature from each other and aligning with the individually controllable cooking zones in the cooking apparatus such that the plurality of segments align with the plurality of cooking zones; and
a network accessible storage repository of meal kit information from which the information relating to cooking temperature and cooking time for each segment is retrieved by the cooking apparatus after scanning the machine-readable code disposed on the meal kit.
